(19) United States
(12) Patent Application Publication
(10) Pub. No.: US 2008/0211509 A1
(43) Pub. Date: Sep. 4, 2008

(54) Battery capacity monitoring system and method of displaying capacity thereof

(75) Inventors: Chang-Yu Ho, Hsinchu Hsien (TW); Wen-Jin Huang, Hsinchu City (TW)

Correspondence Address: BIRCH STEWART KOLASCH & BIRCH, PO BOX 747, FALLS CHURCH, VA, 22040-0747, US

(73) Assignee: Neotec Semiconductor Ltd.

(21) Appl. No.: 11/713,055

(22) Filed: Mar. 2, 2007

(51) Int. Cl. G01N 27/403

(52) U.S. Cl. 324/431

(57) ABSTRACT

A system for monitoring the battery capacitor is disclosed. The system comprises an ADC (analog to digital converter), a CPU, a ROM, a clock generator, a SMbus (smart management bus) interface. A series of RTC interrupt signals are generated by the clock generator and feeds to the CPU. When the CPU receives a RTC interrupt, the CPU runs a program in said ROM to calculate the remaining capacity of the battery and stores it into register or RAM according to the digital signal outputs from the ADC, which converts an analog signal of the battery into a digital signal. The SM bus interface then fetches the calculated results from the CPU and displays them by LED in terms of lighting, dark and flashing.

### FIELD OF THE INVENTION

The present invention is related to a battery capacity monitoring system and a method of displaying the capacity, particularly, to a method of using a battery management chip to display the battery capacity.

### DESCRIPTION OF THE PRIOR ART

Battery is knows as a main power for most of probable electric devices. For instance, mobile phone, Notebook, PDA (personal digital assistance), Walkman, etc., all are relied on the battery to provide their power thereof. The battery, however, saves only limited electrical capacity. As a probable device is turned on, the charges saved in the battery consumed will sustain until power off or the residue electrical capacity is not enough to support the probable device work properly. As the electricity saved in the battery is lower than a critical level, the battery will need to be discarded or recharged. Generally, for the earth environment and the average cost for a long time are concerned, choosing the rechargeable battery as the main power will be the best policy. A typical rechargeable battery can be recharged to replenish its electricity up to several hundreds to thundered times.

Surely, how long a full-charged battery can support a probable device depends on the power consumption and the total time of power on of the probable device. It is also strongly related to charge saving ability of a battery.

The capacity of a battery is known to mainly depend on the material therein and the memory effect thereof. The memory effect is a fact that the physical capacity of a battery saved is found to be gradually lower than its original has due to the probable device can not be completely discharged for a long time. The phenomenon is believed to be due to the properties of some elements. For example, the memory effect of Ni-Cd battery is found to be more serious than Ni-MH battery. The Li-polymer battery is thought to have least memory effect.

One characteristic of the rechargeable battery worth to note is the curve relationship between the terminal voltages versus the remaining electrical capacities of a battery. Please refer to FIG. 1. It shows discharge curves at different temperatures. As shown in FIG. 1, two steeped points are found in each one discharge curve, respectively, at a point near a saturation point and the charges in the battery near empty. At the latter point the charges can be released are rare and the terminal voltage of the battery is plummeted. At this point, the terminal voltage is called End of Discharge Voltage, hereinafter is called EDV. When the terminal voltage of the battery equals to EDV, or called EDV2, the remaining capacity in the battery are about 7-8% of the full scale. The dotted line 5 is plotted according to EDV2 of each discharge curve. It is found that EDV2 is not a constant value but varies with the environmental temperature and the discharge current.

Besides, there is another parameter called EDV0, see the dotted line 7, for the situation of the remaining capacity is completely empty i.e., 0% of the full scale. In fact, the battery voltage of the probable device will not be discharged to EDV0 or even EDV2 to avoid risk of data loss in RAM (random access memory) of a probable device. Even more serious, if the probable device is a medical appliance for a patent, the power loss will cause the patent falls into a dangerous situation immediately.

Hence, for a smart battery management system, it should at least have remaining capacity monitoring ability and issue an alarm signal to the user while the remaining capacity is close to 10% or 20%. Another additional preferred function for the smart battery management system is by turning off the power while reaching the EDV2 so as to avoid shrinkage the life time of the battery.

Still, as shown in FIG. 1, the EDV2 of a battery is not a constant value. Typically, the EDV2 is changed with the battery aging, the loading current of the probable device, and an environmental temperature.

Thus an object of the present invention is to provide a method for determining EDV2 and EDV0 at any temperature and the discharge current.

### SUMMARY OF THE INVENTION

A system for monitoring the battery capacitor is disclosed. The system comprises an ADC (analog to digital converter), a CPU, a ROM, a clock generator, a SMbus (smart management bus) interface. A series of RTC interrupt signals are generated by the clock generator and feeds to the CPU. When the CPU receives a RTC interrupt, the CPU runs a program in said ROM to calculate the remaining capacity of the battery and stores it into register or RAM of a SMbus according to the digital signal outputs from the ADC, which converts an analog signal of the battery into a digital signal. The SM bus interface then fetches the calculated results and displays them by LED in terms of lighting, dark and flashing.

Since the RTC interrupt generated is by hardware interrupt rather than software interrupt and the CPU runs the program in the ROM while receiving a RTC interrupt, the battery monitor system thus consumes minimum resource of the CPU. Furthermore, in accordance with the present invention, the remaining capacity of the battery can be read by five LEDs according to the number of LEDs in lighting, dark and flashing. Though it is simple and least current consume, however, the resolution can reach up to 10%.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is discharging curves of a battery at various of temperatures showing the EDV2 and EDV0 are not a constant value but depends on the temperature and discharging current.

FIG. 2 is a function block showing the measuring system for battery.

FIG. 3 shows RTC interrupt pulses.

### DESCRIPTION OF THE PREFERRED EMBODIMENT

As aforementioned descriptions in the background of the present invention, the EDV2 (7% of the full-charged capacity) is influenced by environmental temperature of the battery and sustained discharged current (or say loading current). It is thus desired to find a formula to estimate EDV2 and EDV0 at arbitrary environmental temperature and the sustained discharged current.

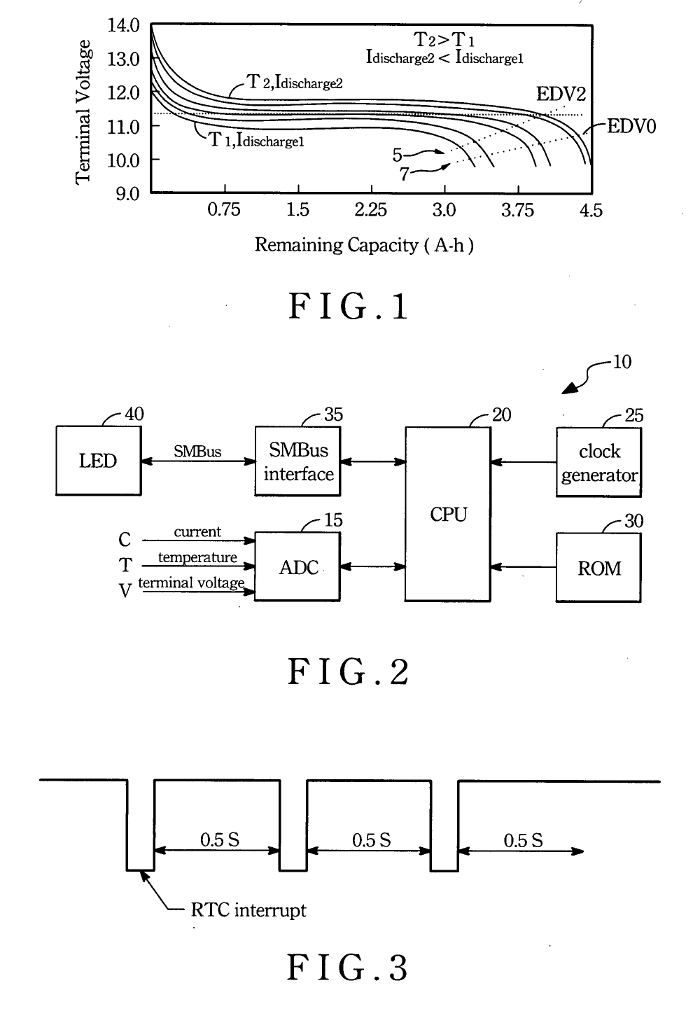

According to a preferred embodiment of the present invention, the EDV2 can be estimated from a empirical formula (I) depicted below and EDV0 can be estimated from a empirical formula (II) depicted below too. FIG. 1 shows a discharging curve typically for a battery, wherein, the X-axis is the remaining capacity of the battery and the Y-axis is the terminal voltage of the battery which may be one cell or a plurality of cells in series connected. According to measurements of the present invention, the discharging curves are found that each can be divided into two piecewise of curves, which are, respectively, approximately consistent with the empirical formulas (or called estimated curve):

EDV2=EMC*(256−(I_{discharge}/64+Q_{T})*EDV_gain/256)/256; (I)

EDV₀=EMC*(256−(I_{discharge}/64+Q_{T})*EDV_factor/256)/256; (II)

In the equations: I_{discharge} and Q_{T} are two variables, where Q_{T} is temperature related variable and I_{discharge} is a discharging current;

Q_{T}=[480−(T−5)*10]*8/256; and (III)

where the I_{discharge} is with unit of mA and T with unit of ° C. as putting into the equations.

Accordingly, the parameters EMC, EDV_factor, and EDV_gain are coefficients of the two variable empirical equations and can be obtained by boundary conditions. The “EDV_factor’ is the slop of the estimated curve (II) and the “EDV_gain’ is the slop of the estimated curve (I).

The boundary condition is set at a constant discharge rate between about 50%-150% of the full scale battery capacity at a temperature range between about 5° C.-45° C. For instance, the discharging current is set to be 2200 mA for a fully charged battery 4400 mAh of a Notebook having a battery consisting of three cells in series.

Three sets of EDV2, EDV0 are determined from three discharging curves, respectively, at temperature of about 45° C., 25° C., and 5° C. and a constant discharge current I_{discharge} of about 50% of the full scale battery capacity for one hour discharge. Surely, the aforementioned boundary conditions are for illustrating convenient only but it does not intend to limit the claim scopes. Besides forgoing temperatures are environmental temperatures rather than the surface temperatures of the battery.

Therefore, three known values of Q_{T1}, Q_{T2}, Q_{T3} can be derived by equation (III) with T=5° C., 25° C., and 45° C., respectively. Another known value I_{discharge} is 2200 mA. Equation (1) contains two unknown coefficients: EMC, and EDV_gain, and Equation (2) contains unknown coefficients: EMC, and EDV_factor. Principally, two boundary conditions would be thus enough to solve the equations (I) and (II).

Since the equations (I), (II), (III) are empirical equations. The extra one boundary set at room temperature is used for calibration while the empirical equations are departed from the real discharging curve. If the departure is out of a tolerated limitation, average values of EMC, EDV_factor, and EDV_gain coefficient are taken by averaging three sets of them derived from three pair boundary conditions.

According to a preferred embodiment of the present invention, the discharging data measurement is implemented by a measuring system 10, as shown in FIG. 2. The measuring system 10 includes an ADC (analog to digital coveter) 15, a CPU (center process unit) 20, a clock generator 25, ROM (read only memory) 30, a SMBus (smart battery management) interface 35, and LEDs (light emission diodes) 40. The SMBus interface 35 is connected in between the CPU 20 and the LEDs 40. The clock generator 25 is provided for CPU 20 operation and will issue an interrupt pulse signal in a period of time, as is shown in FIG. 3. The time period showing in the FIG. 3 is 0.5 s. When a pulse low occurrence, it will trigger the interrupt pin of the CPU 20 to generate an interrupt. The interrupt is called RTC (real time clock) interrupt. When a RTC interrupt is occurred, the CPU will output the battery related information such as the temperature of the battery, loading current (or called discharging current and the digital terminal voltage of the battery through the ADC 15. The CPU 20 executes the commands stored in the ROM 30 to calculate the remaining capacity stored in the battery according the digital terminal voltage. The results are stored in the registers or memory of the SMBus interface 35. The SMBus interface 35 is then timely outputting the residue electrical capacity data either by a LED display or just by an indicator of LEDs.

In more detailed descriptions, as a current flow through the loading resistor, the analog voltage is measurement by taking the voltage drop of the resistor and then converted it to digital signal by ADC 15. The surface temperatures of the battery are measured by any temperature sensor such as thermal couple. The voltage detected by the thermal couple is also converted to digital signal through ADC 15. Aforementioned digital data are then calculated by programs stored in the ROM 30 to obtain the residue electrical capacity and surface temperature.

A battery capacity is known to use “mAh” (10⁻³ A-hour) as unit. Since it relates to the real time, the time of each RTC interrupt is thus demanded to be calibrated before leaving a factory so as to correct monitoring the remaining capacity of a battery. The period of the RTC interrupt is thus calibrated by means of a program stored in ROM. After accumulating a number of RTC interrupts, for example 120 times, the total time costs are then calibrated by reference clocks. In accordance with the present invention, a low cost crystal oscillator is preferred to act as a reference clock generator. The residue electrical capacity of the battery is:

Residue electrical capacity=total charges after fully charged+charges of flowing in−charges of flowing out−self-releasing charges of the battery.

The total charges are integral result of current versus time. The current can be calculated by a voltage drop across the loading resistor. If a voltage difference of a detected voltage minus a reference voltage is negative, the voltage difference is stored in the DC (discharge counter) of a battery protective IC. Otherwise, the voltage difference is stored in the CC (charge counter) of a battery protective IC. The residue electrical capacity can be calculated according to a voltage difference between CC and DC.

To facilitate a user knowing the remaining capacity of the battery therein soon, rather than using a digital indicator, simple LED indicators are instead in according to the present invention. A LED indicator can have a status of lighting (turn on), dark (turn off), or flashing (injecting with pulse current) according to the current injection. Preferably, the LED indicators are composed of five LEDs arranged in a line array, which provides 10% of the full capacity in resolution in accordance with a first preferred embodiment of the present invention.

Accordingly, the remaining capacity of a battery can be read by the number of LEDs, in lighting, or/and flashing according to following simple formulas:

When one LED is flashing:

Remaining capacity=(numbers of lighting LEDs−1)×20%+1(flashing LED)×(0 to 10%);

When no LED is flashing:

Remaining capacity=(numbers of lighting LEDs−1)×20%+(10% to 20%)

Consequently, table 1 lists a reference mapping table for five LED indicators to express the remaining capacity.

| | | | | | Remaining |
|---|---|---|---|---|---|
| 1^{st} LED | 2^{nd} LED | 3^{rd} LED | 4^{th} LED | 5^{th} LED | capacity(%) |
| lighting | lighting | lighting | lighting | lighting | 90–100 |
| lighting | lighting | lighting | lighting | flashing | 80–90 |
| lighting | lighting | lighting | lighting | dark | 70–80 |
| lighting | lighting | lighting | flashing | dark | 60–70 |
| lighting | lighting | lighting | dark | dark | 50–60 |
| lighting | lighting | flashing | dark | dark | 40–50 |
| lighting | lighting | dark | dark | dark | 30–40 |
| lighting | flashing | dark | dark | dark | 20–10 |
| lighting | dark | dark | dark | dark | 10–20 |
| flashing | dark | dark | dark | dark | 0–10 |

In accordance with a second preferred embodiment, the LED indicator array is composed of four LEDs, which can provide a resolution of 12.5%. Other embodiments include three LEDs to provide a resolution of 16% and two LEDs to provide a resolution of 25%.

Table 2 lists a reference table for four LEDs to express the remaining capacity.

| | | | | Remaining |
|---|---|---|---|---|
| 1^{st} LED | 2^{nd} LED | 3^{rd} LED | 4^{th} LED | capacity(%) |
| lighting | lighting | lighting | lighting | 87.5–100 |
| lighting | lighting | lighting | flashing | 75–87.5 |
| lighting | lighting | lighting | dark | 62.5–75 |
| lighting | lighting | flashing | dark | 50–62.5 |
| lighting | lighting | dark | dark | 37.5–50 |
| lighting | flashing | dark | dark | 25–37.5 |
| lighting | dark | dark | dark | 12.5–25 |
| flashing | dark | dark | dark | 0–12.5 |

Table 3 lists a reference mapping table for three LEDs to express the remaining capacity.

| | | | Remaining |
|---|---|---|---|
| 1^{st} LED | 2^{nd} LED | 3^{rd} LED | capacity(%) |
| lighting | lighting | lighting | 83–100 |
| lighting | lighting | flashing | 66–83 |
| lighting | lighting | dark | 50–66 |
| lighting | flashing | dark | 33–50 |
| lighting | dark | dark | 16–33 |
| flashing | dark | dark | 0–16 |

The benefits of the present invention are:

(1) High precision oscillator is not necessary but low cost oscillator would be preferred.

(2) The interrupt signal generated is by RTC hardware rather than software. The CPU 20 then runs the commands about the battery monitoring data. Thus, the battery monitor system consuming minimum resource of the CPU is expected.

(3) Besides, only five LEDs are utilized to express the remaining capacity. Thought it is simple but the resolution can reach up to 10% of the full capacity.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A battery monitoring system, comprising;
an analog to digital converter (ADC converter) having an input terminal for receiving terminal voltage of a battery to output a digital signal;
a center process unit (CPU);
a read only memory (ROM);
a clock generator to provide clock pulses and real time clock (RTC) interrupt signals for said CPU, further, wherein said CPU runs a program stored in said ROM according to said digital signal to calculate remaining capacity of said battery while receiving a RTC interrupt signal and storing a result of remaining capacity;
a line array of LEDs;
a SMbus coupled with said CPU and said LEDs; and
said SMBus lighting a number of said LEDs according to said remaining capacity.

2. The battery monitoring system according to claim 1 wherein said clock generator outputs a RTC interrupt signal per predetermined time period, and said predetermined time period is calibrated before leaving a factory.

3. The battery monitoring system according to claim 1 wherein said LEDs are arranged in a line array and expressing said remaining capacity by lighting, dark, and flashing.

4. The battery monitoring system according to claim 3 wherein when said LEDs are five LEDs; said remaining capacity are expressing by formulas:
remaining capacity=(number of LEDs lighting×20%+0-10%, when one LED is flashing; and
remaining capacity=(number of LEDs lighting×20%+10%-20%, when no LED is flashing.
